(19) United States
(12) Patent Application Publication
(10) Pub. No.: US 2007/0047708 A1
(43) Pub. Date: Mar. 1, 2007

(54) Voice call reply using voice recognition and text to speech

(75) Inventors: Marc A. Boillot, Plantation, FL (US); Philip A. Schentrup, Hollywood, FL (US); John G. Harris, Gainesville, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/216,283

(22) Filed: Aug. 31, 2005

(51) Int. Cl. H04M 15/06; H04M 1/56

(52) U.S. Cl. 379/142.01

(57) ABSTRACT

A voice reply system (200) suitable for handling an incoming call. The voice reply system can include a reply handler (220) that, responsive to receiving the first spoken utterance from a user (250) speaking into a headset (110), audibly provides to the user a caller identifier sound token correlating to the incoming call. The voice reply system also can include a call handler (210) that, responsive to the reply handler receiving a second spoken utterance from the user, implements at least one routine that handles the incoming call. For example, the routine can automatically provide a predetermined reply to a caller (240). The reply handler also can include a voice recorder (226) that can append a voice note onto the predetermined reply to provide a combined reply to the caller.

### BACKGROUND OF THE INVENTION

1. Field of the Invention

The present invention generally relates to communication devices and, more particularly, to communication devices that receive incoming calls.

2. Background of the Invention

Mobile telephones often include a blue tooth interface for communicating with a wireless headset. The wireless headset enables a user to converse over the telephone without the necessity of holding the telephone in hand. Tactile inputs are still required to receive a call or play a message, however. Moreover, to access a mobile telephone's caller identification functionality, it is generally necessary for the user to manipulate the telephone in hand so as to provide a proper viewing angle for reading a caller identifier from the telephone's display. Thus, currently available mobile communication devices fail to provide complete hands free operation.

### SUMMARY OF THE INVENTION

The present invention relates to a voice reply system that facilitates hands free call handling, including hands free operation of voice identification functions. The voice reply system can include a reply handler that, responsive to receiving a first spoken utterance from a user speaking into a headset, audibly provides to the user a caller identifier sound token correlating to the incoming call. The reply handler can include a speech recognition system that generates the data corresponding to the first spoken utterance or a second spoken utterance.

The reply handler can further include a vocabulary module that matches data corresponding to the first spoken utterance or the second spoken utterance with a predetermined reply. The reply handler also can include a voice recorder cooperatively connected to the speech recognition system. The voice recorder can append a voice note onto the predetermined reply to provide a combined reply to the caller. In addition, the reply hander can include a timer that identifies a time window for receiving the voice note.

The voice reply system also can include a call handler that, responsive to the reply handler receiving the second spoken utterance from the user, implements at least one routine that handles the incoming call. The routine can correlate to the second spoken utterance. For example, the routine can automatically provide a predetermined reply to the caller.

The call handler also can include a caller identification (ID) module that processes a caller ID code present on the incoming call to generate the caller identifier sound token. In another arrangement, the call handler can include a voice identifier that processes a caller spoken utterance to associate the caller with caller information contained in a voice call list.

The present invention also relates to a method for processing an incoming call. The method can include audibly providing to a user a caller identifier sound token correlating to the incoming call. The caller identifier sound token can be provided in responsive to receiving a first spoken utterance from the user via a headset communicatively linked to a communication device. A caller identification code present on the incoming call can be processed to generate the caller identifier sound token. In another arrangement, a caller spoken utterance can be processed to associate the caller with caller information contained in a voice call list.

In response to receiving a second spoken utterance via the headset, at least one routine for handling the incoming call can be implemented. The routine can correlate to the second spoken utterance. The routine can, for example, automatically provide a predetermined reply to the caller. The routine also can implement processing of data corresponding to the second spoken utterance to select a predetermined reply. In addition, a voice note can be recorded and appended onto the predetermined reply to create a combined reply. A timer can be started to identify a time window for receiving the voice note. The combined reply can be provided to the caller. Speech recognition can be implemented to generate data corresponding to the first spoken utterance or the second spoken utterance.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communication device and a headset which are useful for understanding the present invention.

FIG. 2 is a block diagram of a voice reply system useful for understanding the present invention.

FIG. 3 is a flowchart useful for understanding the present invention.

### DETAILED DESCRIPTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention relates to a method and a system that may be implemented by a user in a hands free manner to respond to a call, such as an incoming telephone call, without actually entering into a formal voice call dialogue. In particular, the user can respond to an incoming call by uttering instructions to a voice reply system. For example, when a call is received, the user can utter “who is it?” In response, the system can process a caller identifier (ID) associated with the received call to generate a caller identifier sound token, and forward the caller identifier sound token to the user. The caller identifier sound token can be an audio data file that is used by the headset to generate an audio signal to the user. The user can respond to the audio signal with another utterance that instructs the system to implement a selected call handling routine. For instance, the user can instruct the system to answer the call, to send the call to voice mail, or to provide a specific message.

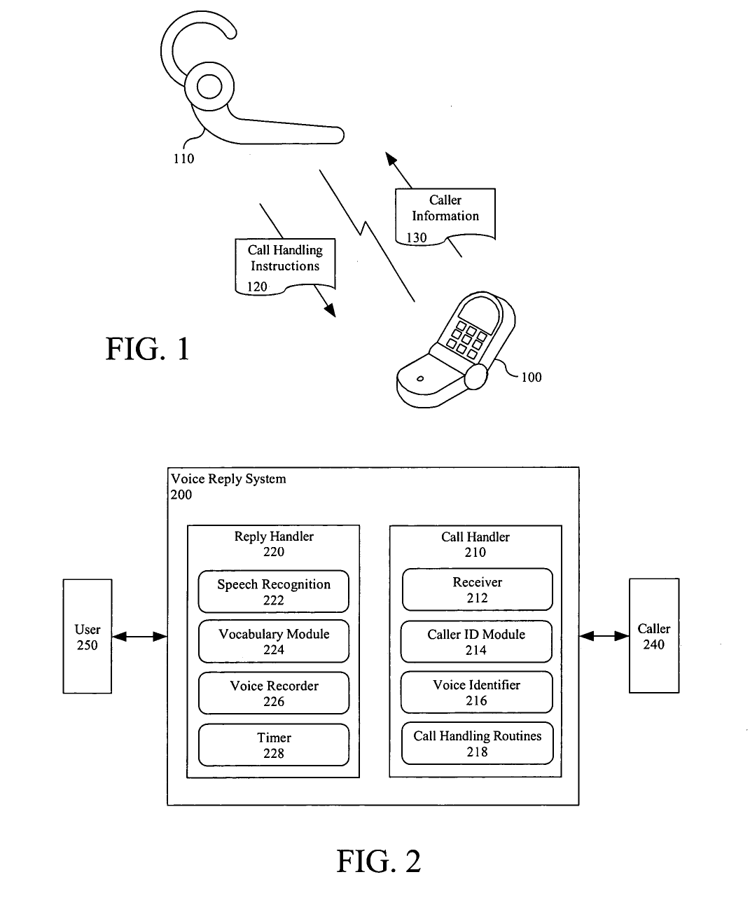

FIG. 1 depicts a communications device 100 and a headset 110 which are useful for understanding the present invention. The communications device 100 can be a wired communications device, such as a telephone or computer, or a wireless communications device, such as a mobile telephone, a personal digital assistant (PDA) or a mobile computer.

The headset 110 can include at least one audio transducer (not shown) for propagating acoustic signals to a user and for receiving spoken utterances from the user. The headset 110 can be communicatively linked to the communications device 100 via a fiber optic, wired, or wireless communications link. For instance, the headset 110 can wirelessly communicate with the communications device 100 via radio frequency (RF) or infrared signals. In one arrangement, the headset 110 can communicate with the communications device 100 via blue tooth or any other suitable protocol.

In operation, the communications device 100 can alert the user when an incoming call is received. For example, the communications device 100 can generate a ring tone or communicate a message to the headset 110 that notifies the user of an incoming call. In response, the user can issue call handling instructions 120 with a spoken utterance. For example, the user may utter “who is it?” Responsive to the spoken utterance, caller information 130 that identifies the caller to the user can be forwarded to the headset 110. The caller information 130 can be any suitable message that identifies the caller to the user. The caller information 130 can include, for instance, a caller identifier sound token that corresponds to the caller, or data which can be used to select the appropriate caller identifier sound token.

In one arrangement, the caller information 130 can be a voice signal corresponding to the caller. For instance, in response to the call handling instructions 120, the caller can be asked to utter his name, and the caller information 130 can contain data corresponding to the caller's spoken utterance. In another arrangement, a caller identification (ID) generated by a telecommunications carrier can be processed to generate data contained in the caller information 130. In yet another arrangement, the caller's voice patterns can be processed and compared to known voice profiles to generate a caller identifier sound token contained in the caller information 130. Still, the invention is not limited in this regard and any suitable method for identifying the caller to the user is within the scope of the present invention.

FIG. 2 is a block diagram of a voice reply system 200 that is useful for understanding the present invention. The voice reply system 200 can be contained in the communications device, the headset, or in another device that is communicatively linked to the communications device and the headset. In an alternate arrangement, a portion of the voice reply system 200 can be contained in one device, such as the communications device, while another portion of the voice reply system 200 is contained in one or more other devices, such as the headset. For example, a call hander 210 can be contained in the communications device while a reply handler 220 can be contained in the headset.

The call handler 210 can include a receiver 212 that receives voice communication signals from the caller 240. For example, if the call handler 210 is contained in the communications device and the communications device is a mobile station, the receiver 212 can be a transceiver. If the call hander 210 is contained in the headset and the headset communicates with the communications device via the blue tooth protocol, the receiver 212 can be a blue tooth compatible receiver. Still, a myriad of other receiver types are known to the skilled artisan and the invention is not limited in this regard.

The call handler 210 also can include a caller ID module 214. The caller ID module 214 can convert a caller ID present on the incoming call to caller information that can be presented acoustically to the user 250 via the headset. For instance, the caller ID module 214 can include a text-to-speech module that converts caller ID text to speech data. In another arrangement, the caller ID module 214 can process the caller ID to select a caller identifier sound token that corresponds to the identity of the caller 240. The caller identifier sound token can include the name of the caller and any other desired information. In yet another arrangement, the caller ID module 214 can store acoustic data corresponding to the caller's spoken utterance when the caller is asked to identify himself. This stored acoustic data can be presented to the user 250 as the caller identifier sound token.

The call handler 210 also can include a voice identifier 216. The voice identifier 216 can be provided in conjunction with, or in lieu of, the caller ID module 214. The voice identifier 216 can compare the caller's voice patterns to known voice profiles to select caller information that corresponds to the caller 240, for example a name or other caller attributes, from a voice call list. Regardless of the method used to identify the caller 240 the call handler 210 can forward the caller information, either directly or indirectly, to the user via the headset. For instance, the call handler 210 can pass the caller information to the reply handler 220, which then forwards the caller information to the user 250.

The call handler 210 also can include one or more call handling routines 218. The call handling routines 218 can be implemented by the call handler 210 to handle incoming calls in accordance with instructions from the user 250 and other pre-defined processes. For instance, the call handling routines 218 can send the call to voice mail, establish bidirectional communication between the caller 240 and the user 250, provide a reply message to the caller 240, or implement any other suitable call processing functions.

The reply handler 220 can include speech recognition 222. The speech recognition 222 can receive acoustic data corresponding to a spoken utterance of the user 250 received via the headset, and convert the acoustic data to text data. The text data can be forwarded to a vocabulary module 224, which can process the text data to select call handling routines. For instance, in response the user 250 uttering a call handling instruction “who is it?” a call handling routine can be triggered which sends an audio message to the caller 240 requesting the caller 240 to identify himself. In another arrangement, the call handling routine can activate the caller ID module 214 and/or the voice identifier module 216 to identify the caller 240.

Once the caller 240 has been identified to the user 250, one or more additional spoken utterances can be received from the user 250 to trigger additional call handling routines. For example, the user can utter “connect” to establish a bidirectional communication link with the caller 240, or the user can utter “voice mail” to send the call to voice mail. In another example, the user 250 can utter a command that triggers a call handling routine that selects a predetermined reply to be forwarded to the caller 240, such as “I am currently not available . . . ”

In yet another example, the reply handler 220 can include a voice recorder 226. The user 250 can be prompted to generate another spoken utterance which may be recorded by the voice recorder 226 to generate a voice note. The voice note can be appended to a pre-determined reply to generate a combined reply. For instance, the user can select a pre-determined reply that states “I am currently not available, but will return your call.” In response, the user 250 can be prompted to utter a time and/or day in which the call will be returned. Accordingly, the combined reply that is forwarded to the caller 240 can be, for example, “I am currently not available, but will return your call tomorrow morning.” Of course, the pre-determined portion of the reply can be pre-recorded by the user or pre-configured into the reply handler 220.

The reply handler 220 also can include a timer 228 to establish a duration for receiving the voice note. For instance, the timer 228 may be set to ten seconds to provide the user 250 ten seconds to enter the utterance that generates the voice note. The timer 228 may also be used to time audible tones that are provided to the user 250 to indicate when the user should utter the reply.

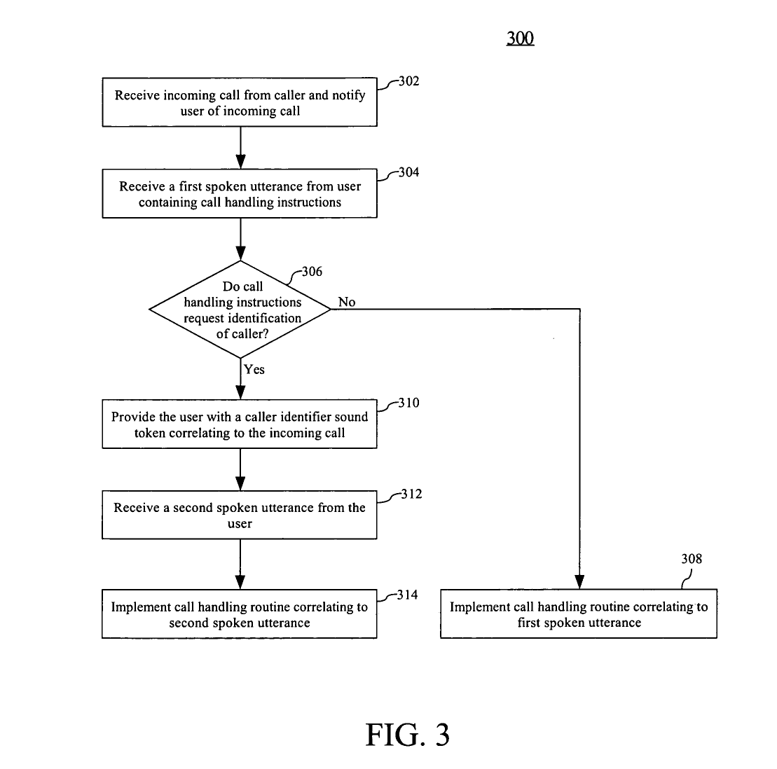

FIG. 3 is a flowchart that presents a method 300 which is useful for understanding the present invention. Beginning at step 302, an incoming call can be received from the caller and the user can be notified. At step 304, a first spoken utterance containing call handling instructions can be received from the user. Referring to decision box 306 and step 308, if the call handling instructions do not request identification of the caller, a call handling routine correlating to the first spoken utterance can be implemented. For instance, if the spoken utterance is “send to voice mail,” the caller can be connected to the user's voice mail.

If, however, the call handling instructions request identification of the caller, the user can be provided with a caller identifier sound token correlating to the incoming call, as shown in step 310. For instance, the caller identifier sound token can be an audio signal that provides to the user the caller's name and/or any other information associated with the caller. Proceeding to step 312, a second spoken utterance can be received from the user. Continuing to step 314, a call handling routine correlating to the second spoken utterance then can be implemented. The method 300 is but one example of call processing. However, the invention is not limited to this example and a plurality of other types of hands free call handling processes can be implemented.

The present invention can be realized in hardware, software, or a combination of hardware and software. The present invention can be realized in a centralized fashion in one system, or in a distributed fashion where different elements are spread across several interconnected systems. Any kind of processing device or other apparatus adapted for carrying out the methods described herein is suited. A typical combination of hardware and software can be a processing device with an application that, when being loaded and executed, controls the processing device such that it carries out the methods described herein.

The present invention also can be embedded in an application program product, which comprises all the features enabling the implementation of the methods described herein, and which when loaded in a processing device is able to carry out these methods. Application program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A voice reply system suitable for handling an incoming call, comprising:
a reply handler that, responsive to receiving a first spoken utterance from a user speaking into a headset, audibly provides to the user a caller identifier sound token correlating to the incoming call; and
a call handler that, responsive to the reply handler receiving a second spoken utterance from the user, implements at least one routine that handles the incoming call, the routine correlating to the second spoken utterance.

2. The voice reply system of claim 1, wherein the call handler further comprises a caller identification (ID) module that processes a caller ID code present on the incoming call to generate the caller identifier sound token.

3. The voice reply system of claim 1, wherein the call handler further comprises a voice identifier that processes a caller spoken utterance to associate the caller with caller information contained in a voice call list.

4. The voice reply system of claim 1, wherein the routine correlating to the second spoken utterance automatically provides a predetermined reply to the caller.

5. The voice reply system of claim 1, wherein the reply handler further comprises:
a vocabulary module that matches data corresponding to the first spoken utterance or the second spoken utterance with a predetermined reply; and
a voice recorder cooperatively connected to the speech recognition system that appends a voice note onto the predetermined reply to provide a combined reply to the caller.

6. The voice reply system of claim 5, wherein the reply hander further comprises a timer that identifies a time window for receiving the voice note.

7. The voice reply system of claim 1, wherein the reply handler further comprises a speech recognition system that generates data corresponding to the first spoken utterance or the second spoken utterance.

8. A machine readable storage, having stored thereon a computer program having a plurality of code sections executable by a machine for causing the machine to perform the steps of:
responsive to receiving a first spoken utterance from a user via a headset communicatively linked to a communication device, audibly providing to the user a caller identifier sound token correlating to the incoming call; and
responsive to receiving a second spoken utterance via the headset, implementing at least one routine for handling the incoming call, the routine correlating to the second spoken utterance.

9. The machine readable storage of claim 8, wherein audibly providing to the user a caller identifier sound token further comprises processing a caller identification code present on the incoming call to generate the caller identifier sound token.

10. The machine readable storage of claim 8, wherein audibly providing to the user a caller identifier sound token further comprises processing a caller spoken utterance to associate the caller with caller information contained in a voice call list.

11. The machine readable storage of claim 8, wherein implementing the routine further comprises automatically providing a predetermined reply to the caller.

12. The machine readable storage of claim 8, wherein implementing the routine further comprises:
processing data corresponding to the second spoken utterance to select a predetermined reply;
recording a voice note;
appending the voice note onto the predetermined reply to create a combined reply; and
providing the combined reply to the caller.

13. The machine readable storage of claim 12, further comprising starting a timer that identifies a time window for receiving the voice note.

14. The machine readable storage of claim 8, further comprising implementing speech recognition to generate data corresponding to the first spoken utterance or the second spoken utterance.

15. A method for processing an incoming call, comprising:
responsive to receiving a first spoken utterance from a user via a headset communicatively linked to a communication device, audibly providing to the user a caller identifier sound token correlating to the incoming call; and
responsive to receiving a second spoken utterance via the headset, implementing at least one routine for handling the incoming call, the routine correlating to the second spoken utterance.

16. The method according to claim 15, wherein audibly providing to the user a caller identifier sound token further comprises processing a caller identification code present on the incoming call to generate the caller identifier sound token.

17. The method according to claim 15, wherein audibly providing to the user a caller identifier sound token further comprises processing a caller spoken utterance to associate the caller with caller information contained in a voice call list.

18. The method according to claim 15, wherein implementing the routine further comprises automatically providing a predetermined reply to the caller.

19. The method according to claim 15, wherein implementing the routine further comprises:
processing data corresponding to the second spoken utterance to select a predetermined reply;
recording a voice note;
appending the voice note onto the predetermined reply to create a combined reply; and
providing the combined reply to the caller.

20. The method according to claim 15, further comprising implementing speech recognition to generate data corresponding to the first spoken utterance or the second spoken utterance.
